(19) United States
(12) Patent Application Publication
(10) Pub. No.: US 2009/0038426 A1
(43) Pub. Date: Feb. 12, 2009

(54) Haptic Gear Shifter

(76) Inventors: Pietro Buttolo, Dearborn Heights, MI (US); James Rankin, II, Novi, MI (US); Yifan Chen, Ann Arbor, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/836,278

(22) Filed: Aug. 9, 2007

(51) Int. Cl. B60K 20/04

(52) U.S. Cl. 74/473.3

(57) ABSTRACT

The subject of the present invention is a haptic gear shifter and a method of controlling a haptic gear shifter for use in a vehicle or a vehicle simulator. A method is disclosed for establishing gear shifter characteristics, for calibrating a haptic gear shifter, and for operating the haptic gear shifter.

### BACKGROUND OF THE INVENTION

The present invention relates generally to a haptic gear shifter for a motor vehicle or a motor vehicle simulator.

As the market for sales of products becomes more competitive, a manufacturer must distinguish its products from the competition. Thus, a product design may require more than providing the proper function—it may also require providing a certain feel or image for the product. For example, a mechanism, such as a vehicle gear shifter, may need to not only perform its function of causing gear changes, but also provide a certain feel to the vehicle operator while being actuated. Such a feel may give an impression of quality or distinctiveness to the product. Thus, the human/machine interface for that particular gear shifter must be defined.

Also, shift-by-wire technology is desired where there is an electronic rather than mechanical linkage between the gear shifter and the vehicle transmission. For this technology, it may be desirable to still provide a feel of a conventional gear shifter for the vehicle operator even though there may no longer be a mechanical linkage.

Simulated gear shifters have been developed for toys and games (particularly video games) that are modified versions of joysticks, but the quality of rendering is quite poor and unsatisfactory for applications with real vehicles.

### SUMMARY OF THE INVENTION

An embodiment contemplates a method of controlling a haptic gear shifter for use in one of a vehicle and a vehicle simulator, the method comprising the steps of: defining a plurality of gear shifter nodes in space; defining each of the nodes with a corresponding data structure; defining a plurality of segments extending between the plurality of nodes; defining which of the plurality of nodes are end of travel nodes; specifying a travel-effort profile function for each of the segments; and defining hard constraints for movements of the haptic gear shifter.

An embodiment contemplates a method of controlling a haptic gear shifter for use in one of a vehicle and a vehicle simulator, the method comprising the steps of: measuring forces during travel of the haptic gear shifter; separating out components of forces along principal directions of actuation; and making calibration adjustments, based on the components of forces along the principal directions of actuation, to zero out undesired force constraints in the principal directions of actuation.

An embodiment contemplates a method of controlling a haptic gear shifter for use in one of a vehicle and a vehicle simulator, the method comprising the steps of: establishing gear shifter characteristics; calibrating the gear shifter; calculating at least one closest projection of a current position onto at least a corresponding one closest segment of a plurality of segments; applying forces to the haptic gear shifter based on a travel-effort profile for the one closest segment if the projection is not adjacent to two of the segments that are non-parallel; determining a weighted travel-effort profile based on the travel-effort profile for two non-parallel segments and applying the forces to the haptic gear shifter if the projection is adjacent to two of the segments that are non-parallel; and applying collision detection forces to prevent the haptic gear shifter from leaving a boundary of travel if a hard constraint collision is detected.

An advantage of an embodiment is that the haptic gear shifter can be used to improve the shift feel in a vehicle for the operator of the vehicle. This improved feel may improve the perception of vehicle quality for the vehicle operator.

An advantage of an embodiment is that the haptic gear shifter can be used for shift-by-wire technology, while still giving the vehicle operator the sense of driving a conventional vehicle.

An advantage of an embodiment is that the haptic gear shifter can be used with a vehicle simulator to test shift feel quality for a variety of gear shift patterns, with quick changes between tests and repeatable, accurate force feedback of the shift lever.

An advantage of an embodiment is that the haptic gear shifter is computationally efficient, allowing it to run at a high refresh rate.

### BRIEF DESCRIPTION OF THE DRAWINGS

FIG. 1 shows a schematic view of a vehicle simulator having a haptic gear shifter in accordance with an embodiment.

FIG. 2 shows a schematic view of a vehicle having a haptic gear shifter in accordance with an embodiment.

FIG. 3 shows a schematic view of a haptic gear shifter.

FIG. 4 is a flow chart showing an overall method applicable to the haptic gear Shifter.

FIG. 5 is a flow chart showing a method of establishing haptic gear shifter characteristics.

FIG. 6 is a flow chart showing a method of calibrating the haptic gear shifter.

FIG. 7 is a flow chart showing a method of operating the haptic gear shifter.

FIG. 8 is a flow chart showing the details of finding the haptic gear shifter hard constraints.

FIGS. 9A-9E show schematic diagrams relating to an example for defining haptic gear shifter hard constraints.

FIGS. 10A-10C show diagrams relating to topology information associated with gear shifter positions.

FIGS. 11A-11B show diagrams relating to force profile structures specifying travel effort functions for particular topological data information.

### DETAILED DESCRIPTION

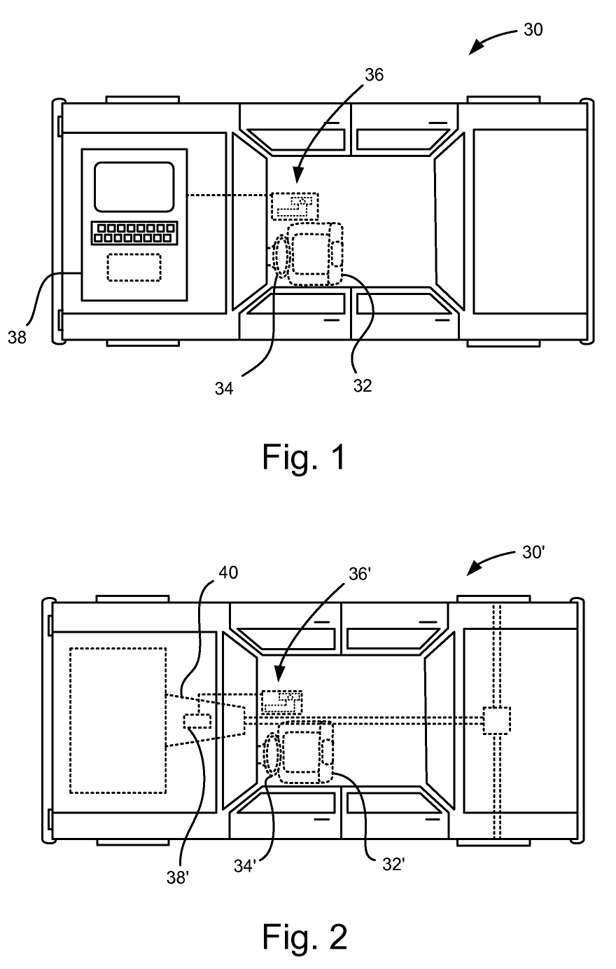

FIG. 1 shows a vehicle simulator 30 that may have a driver's seat 32 and a steering wheel 34 located next to a haptic gear shifter 36 in an arrangement that simulates a layout in a real vehicle. The haptic gear shifter 36 is in communication with and controlled by a simulation controller 38, which may be a general purpose personal computer or some other type of computing device. The simulation controller 38 can cause the haptic gear shifter 36 to render various patterns of gear shifters and also control the force feedback to define the feel of the shift at and between each gear location.

FIG. 2 shows a vehicle 30‘having a driver’s seat 32′ and a steering wheel 34′ located next to a haptic gear shifter 36′. The haptic gear shifter 36′ is in communication with and controller by an electronic controller 38′, which may be part of a transmission controller or a separate controller in communication with a controller for a transmission 40. The haptic gear shifter 36′ renders the desired gear shift pattern for this vehicle 30′, as well as the force feedback to define the feel of the shift at and between each gear location.

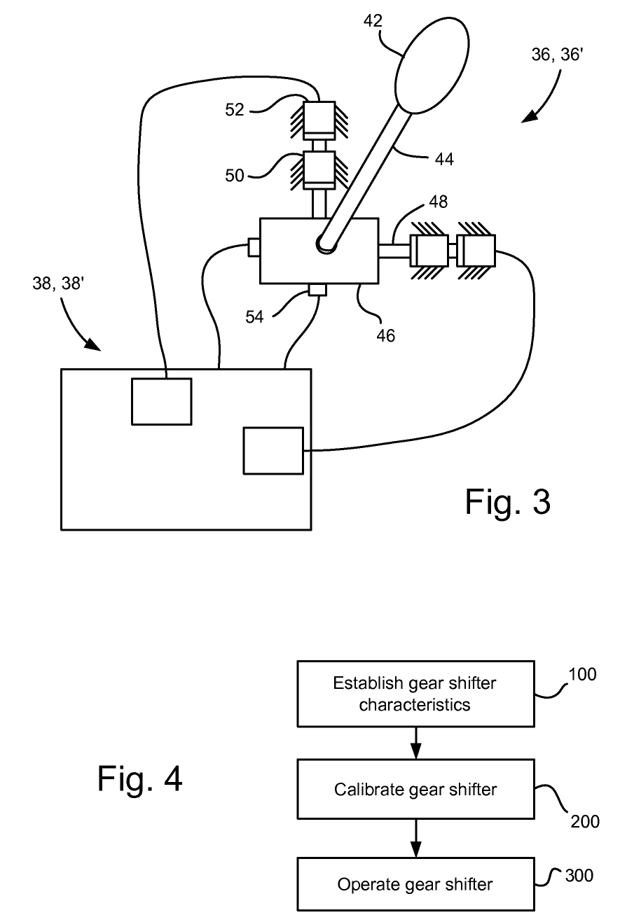

FIG. 3 shows an example of a haptic gear shifter 36 or 36′ that may be used with the embodiments of FIGS. 1 and 2. The haptic gear shifter 36, 36′ may include a gear knob 42 mounted on an upper end of a shaft 44. A lower end of the shaft 44 connects to a pivot mechanism 46 allowing for, basically, two-degree-of-freedom motion. A pair of bars 48 connect to planetary gear heads 50, which are, in turn, driven by a pair of motors 52. The motors 52 may be brushless and driven by linear amplifiers (not shown) to minimize the noise emitted by the system. Friction elements (not shown) may be employed to improve the perceived quality of wobble and the stability of the system. Optical incremental rotary encoders 54 (or other means of sensing position/motion) may be employed to sense motion. The controller 38 or 38′ is in communication with and controls the various elements of the haptic gear shifter 36 or 36′, respectively.

The haptic gear shifter 36, 36′ is capable of accurately rendering any arbitrary shifter feel and movements, and as such can be used in the vehicle simulator 30 as a tool to collect customer preferences and determine shifter quality perception, as well as the vehicle interface in a steer-by-wire configuration of a vehicle 30′. Applying the methods discussed below with this haptic gear shifter 36, 36′ allows it to run computationally efficient, as well as accurately rendering not only existing gearshift patterns, but also new patterns and layouts that may arise in the future.

FIG. 4 is a flow chart showing an overall method applicable to the haptic gear Shifter 36, 36′ (shown in FIGS. 1-3). The gear shifter characteristics are established, block 100. The gear shifter is calibrated, block 200, and the gear shifter is operated, block 300.

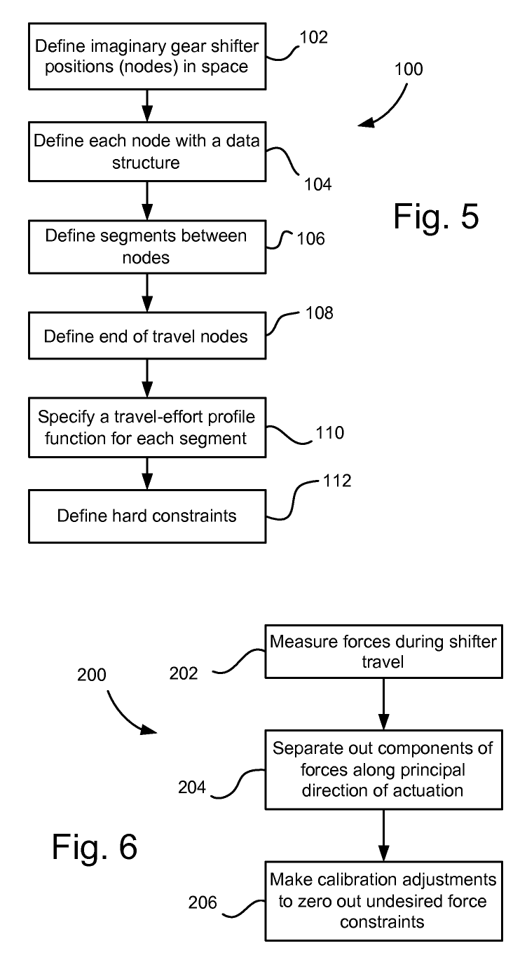

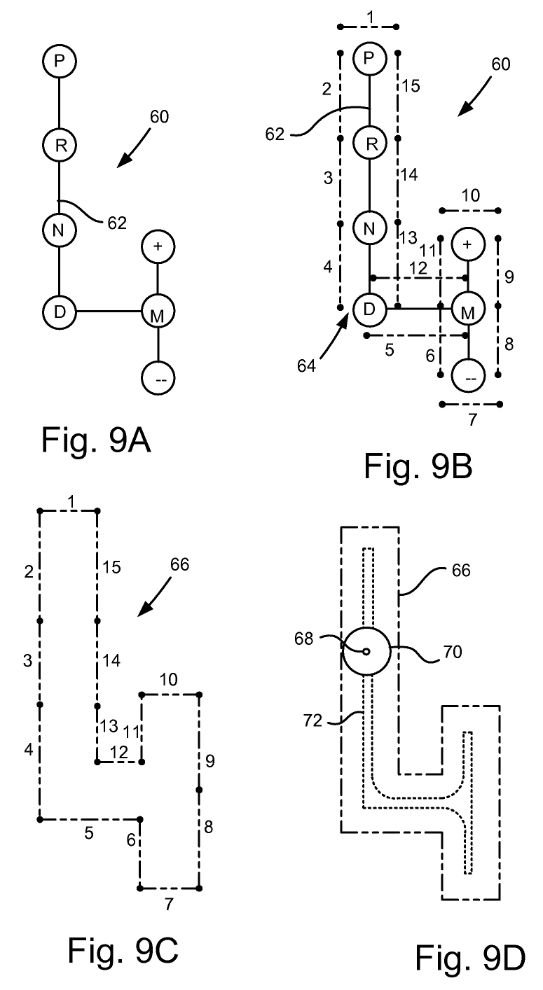

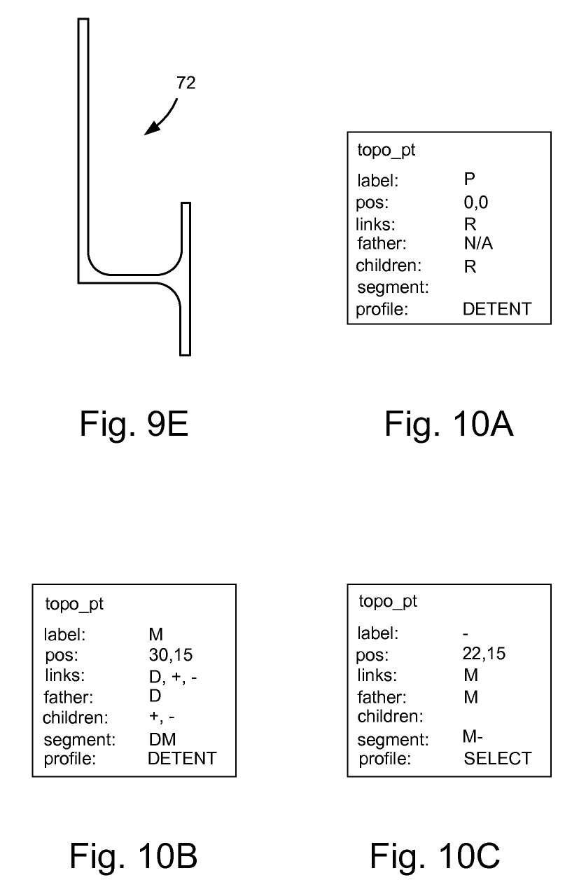

FIG. 5 illustrates the process of block 100 of FIG. 4, in more detail. FIG. 5 will be discussed with reference to FIGS. 9A, 10A-10C, and 11A-11B. Imaginary gear shifter positions (nodes) are defined in space, block 102. FIG. 9A shows the nodes for an example of a gear shift pattern 60—P for park, R for reverse, N for neutral, D for drive, M for manual, + for manual upshift, and − for manual downshift. Each node is defined with a data structure, block 104. FIG. 10A shows a sample data structure (top( )_pt) for the park (P) node. It may include a label, relative position, other nodes it is linked to (in this case reverse (R)), a father node (not included for the park detent), children nodes (reverse (R)), and a travel-effort profile (DETENT). The father and children nodes represent topological neighbors (adjacent nodes) that the shifter can move between, which allows the data structures to also be used to represent detent-to-detent segments 62. The segments 62 between the nodes are defined, block 106. FIG. 10B shows a sample data structure for the manual (M) node and drive-manual (D-M) segment 62. FIG. 10C shows a sample data structure for the downshift (−) node and manual-downshift (M−−−) segment 62. End of travel nodes are defined, block 108. In the example of FIG. 9A, the end of travel nodes are park (P), upshift (+), and downshift (−). They can be identified by the lack of a father or child node in the data structures.

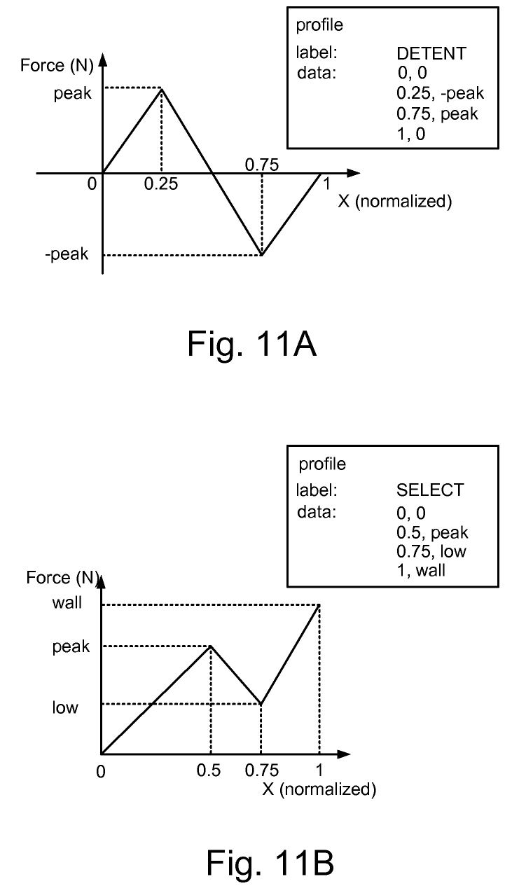

A travel-effort profile function is specified for each segment 62, block 110. FIG. 11A shows a sample travel-effort profile DETENT that is associated with the data structures of FIGS. 10A and 10B, indicating the force profile the shifter will experience moving from park (P) to reverse (R) and from drive (D) to manual (M), respectively. In this sample, the force will begin at zero and increase as the shifter is pulled out of the first detent (node), begin declining about one quarter of the way to the next node, cross a zero force point about half way between the nodes, increase negatively until about three quarters of the way to the next node, and then reduce back to zero force again. FIG. 11B shows a sample travel-effort profile SELECT that is associated with the data structure of FIG. 10C, indicating the force profile the shifter will experience moving from manual (M) to downshift (−). One will note that this travel-effort profile varies from the first in that the downshift node (−) is an end of travel node, so the force increases greatly at the end of travel to simulate the end of movement (running up against a wall)—that is, a simulated hard constraint. Since the shift pattern typically does not include actual physical hard constraints, the hard constraints discussed herein are actually simulated hard constraints.

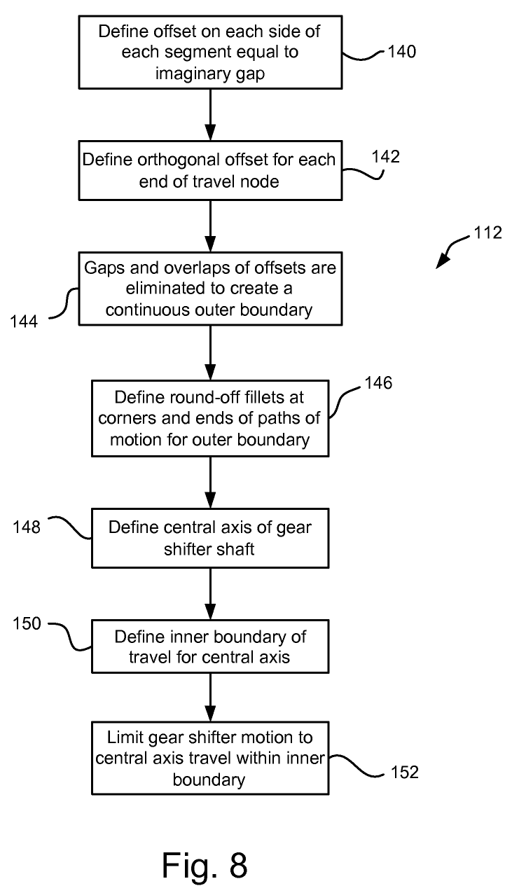

The hard constraints are defined, block 112. The details of defining the hard constraints are illustrated in more detail in FIG. 8, which will be discussed with reference to FIGS. 9A-9E. The sample gear shift pattern 60 for which hard constraints will be defined is shown in FIG. 9A. An offset on each side of each segment equal to an imaginary gap is defined, block 140, and orthogonal offsets for each end of travel node are defined, block 142. FIG. 9B shows offsets (elements 1-15 shown with phantom lines) on each side of segments 62 spaced to form the imaginary gap 64 and end of travel offsets. Gaps and overlaps of offsets are eliminated to create a continuous outer boundary, block 144. FIG. 9C shows the offsets 1-15 forming a continuous boundary 66. This boundary 66, in effect, simulates a real outer physical boundary that a conventional shifter would be subjected to. Round-off fillets at corners and ends of paths of motion for outer boundary are defined, block 146. This step is optional.

A central axis of the gear shifter shaft is defined, block 148. FIG. 9D shows the central axis 68 of the gear shifter shaft 70. Then, an inner boundary of travel for the central axis is defined, block 150. FIG. 9D shows an inner boundary of travel 72 (shown in dashed lines) that is defined by tracing the movement of the central axis 68 as the outer surface of the gear shifter shaft 70 slides around the outer boundary 66. The limits of the gear shifter motion are defined by the central axis travel within the inner boundary, block 152. FIG. 9E, shows the inner boundary 72 that will define the limits of motion. Thus, for the gear shifter model, collision detection is performed on the inner boundary 72 when guiding the motion. By doing this, instead of using polygon-to-polygon intersection algorithms, much simpler and faster point-to-polygon algorithms can be employed for collision rendering. A damper and spring model (not shown) can be used to prevent gear shift shaft from exiting the boundary.

FIG. 6 is a flow chart showing block 200 (calibrating the gear shifter) in FIG. 4 in more detail. The forces during shifter travel are measured, block 202. The components of forces along a principle (unconstrained) direction of actuation are separated-out, block 204. Then, calibration adjustments to zero out undesired force constraints are made, block 206.

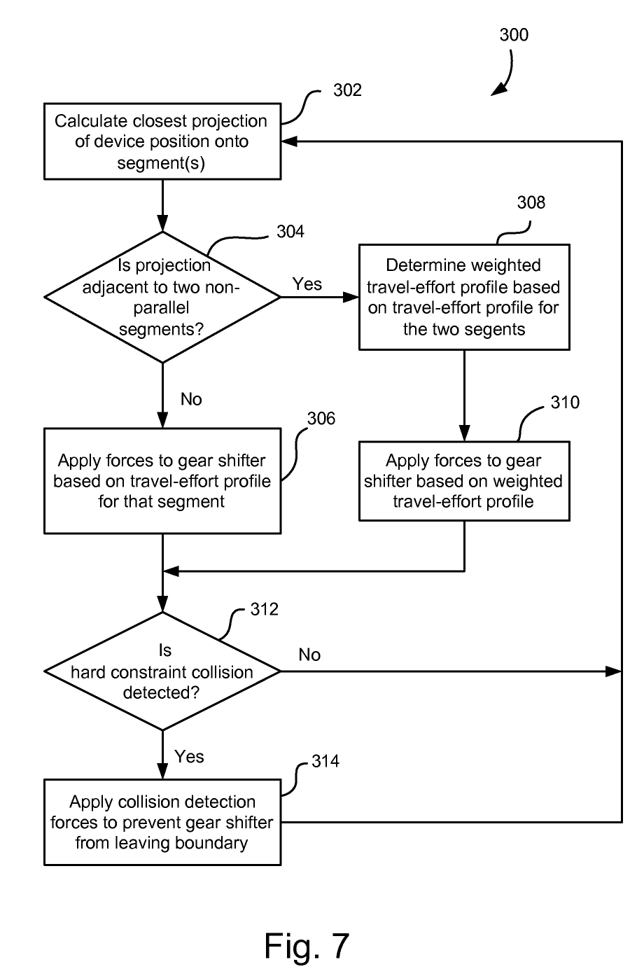

FIG. 7 is a flow chart showing block 300 (operating the gear shifter) in FIG. 4 in more detail. A closest projection of the device (gear shifter) position onto one or more segments is calculated, block 302. The position may be determined by employing the central axis 68 and inner boundary 72 as shown in FIG. 9D. If the projection is adjacent to two non-parallel segments, block 304, then a weighted travel-effort profile based on the travel-effort profile for the two segments is determined, block 308. The travel-effort profiles may be similar to those illustrated in FIGS. 11A and 11B, for segments 62 shown in FIG. 9A having topology data structures similar to those illustrated in FIGS. 10A-10C. The forces are applied to the gear shifter based on the weighted travel-effort profile, block 310. The weighting of profiles for two segments allows for the force feedback to change without jumping discontinuously. If the projection is not adjacent to two non-parallel segments, block 304, then forces are applied to the gear shifter based on the travel-effort profile for that segment, block 306. The forces may be applied by actuating the various elements of the haptic gear shifter 36, 36′ shown in FIG. 3. If a hard constraint collision is detected, block 312, then collision detection forces are applied to prevent the gear shifter from leaving the boundary, block 314. Then the process repeats itself, block 302.

Accordingly, even though there may be no actual fixed hard constraints, various types of gear shift patterns can be simulated and will feel to a vehicle driver like fixed hard constraints actually exists. And, since there are not fixed hard constraints, many different types of shifter patterns can be accurately simulated.

While certain embodiments of the present invention have been described in detail, those familiar with the art to which this invention relates will recognize various alternative designs and embodiments for practicing the invention as defined by the following claims.

What is claimed is:

1. A method of controlling a haptic gear shifter for use in one of a vehicle and a vehicle simulator, the method comprising the steps of:
(a) defining a plurality of gear shifter nodes in space;
(b) defining each of the nodes with a corresponding data structure;
(c) defining a plurality of segments extending between the plurality of nodes;
(d) defining which of the plurality of nodes are end of travel nodes;
(e) specifying a travel-effort profile function for each of the segments; and
(f) defining hard constraints for movements of the haptic gear shifter.

2. The method of claim 1 wherein step (f) is further defined by:
defining an offset on each side of each segment equal to an imaginary gap;
defining an orthogonal offset for each of the end of travel nodes;
creating a continuous outer boundary by eliminating gaps and overlaps between the offsets;
defining a central axis of a gear shifter shaft having an outer diameter;
defining an inner boundary of travel for the central axis by tracking an imaginary motion of the central axis as the outer diameter moves around the continuous outer boundary; and
defining the limits of travel for the haptic gear shifter to motion with the central axis within the inner boundary.

3. The method of claim 2 wherein step (f) is further defined by defining round-off fillets at corners and ends of paths of motion for the continuous outer boundary.

4. The method of claim 2 wherein the step of defining the limits of travel is detected by employing a point-to-polygon intersection algorithm.

5. The method of claim 1 including the step of (g) calibrating the haptic gear shifter.

6. The method of claim 5 wherein step (g) is further defined by:
measuring forces during travel of the haptic gear shifter;
separating out components of forces along principal directions of actuation; and
making calibration adjustments, based on the components of forces along the principal directions of actuation, to zero out undesired force constraints.

7. The method of claim 1 including the step of (g) operating the gear shifter.

8. The method of claim 7 wherein step (g) is further defined by:
calculating at least one closest projection of a current position onto at least a corresponding one of the closest segments;
applying forces to the haptic gear shifter based on the travel-effort profile for the one closest segment if the projection is not adjacent to two of the segments that are non-parallel;
determining a weighted travel-effort profile based on the travel-effort profile for two non-parallel segments and applying the forces to the haptic gear shifter if the projection is adjacent to two of the segments that are non-parallel; and
applying collision detection forces to prevent the haptic gear shifter from leaving a boundary of travel if a hard constraint collision is detected.

9. A method of controlling a haptic gear shifter for use in one of a vehicle and a vehicle simulator, the method comprising the steps of:
measuring forces during travel of the haptic gear shifter;
separating out components of forces along principal directions of actuation; and
making calibration adjustments, based on the components of forces along the principal directions of actuation, to zero out undesired force constraints in the principal directions of actuation.

10. The method of claim 9 including the step of operating the gear shifter.

11. The method of claim 10 wherein the step of operating the gear shifter is further defined by:
calculating at least one closest projection of a current position onto at least a corresponding one closest segment of a plurality of segments;
applying forces to the haptic gear shifter based on a travel-effort profile for the one closest segment if the projection is not adjacent to two of the segments that are non-parallel;
determining a weighted travel-effort profile based on the travel-effort profile for two non-parallel segments and applying the forces to the haptic gear shifter if the projection is adjacent to two of the segments that are non-parallel; and
applying collision detection forces to prevent the haptic gear shifter from leaving a boundary of travel if a hard constraint collision is detected.

12. The method of claim 9 including the step of establishing gear shifter characteristics.

13. The method of claim 9 including the steps of:
defining a plurality of gear shifter nodes in space;
defining each of the nodes with a corresponding data structure;
defining a plurality of segments extending between the plurality of nodes;
defining which of the plurality of nodes are end of travel nodes;
specifying a travel-effort profile function for each of the segments;
defining hard constraints for movements of the haptic gear shifter;
calculating at least one closest projection of a current position onto at least a corresponding one of the closest segments;
applying forces to the haptic gear shifter based on the travel-effort profile for the one closest segment if the projection is not adjacent to two of the segments that are non-parallel;
determining a weighted travel-effort profile based on the travel-effort profile for two non-parallel segments and applying the forces to the haptic gear shifter if the projection is adjacent to two of the segments that are non-parallel; and
applying collision detection forces to prevent the haptic gear shifter from leaving a boundary of travel if a hard constraint collision is detected.

14. The method of claim 13 wherein the step of defining hard constraints is further defined by:
defining an offset on each side of each segment equal to an imaginary gap;
defining an orthogonal offset for each of the end of travel nodes;
creating a continuous outer boundary by eliminating gaps and overlaps between the offsets;
defining a central axis of a gear shifter shaft having an outer diameter;
defining an inner boundary of travel for the central axis by tracking an imaginary motion of the central axis as the outer diameter moves around the continuous outer boundary; and
defining the limits of travel for the haptic gear shifter to motion with the central axis within the inner boundary.

15. A method of controlling a haptic gear shifter for use in one of a vehicle and a vehicle simulator, the method comprising the steps of:
establishing gear shifter characteristics;
calibrating the gear shifter;
calculating at least one closest projection of a current position onto at least a corresponding one closest segment of a plurality of segments;
applying forces to the haptic gear shifter based on a travel-effort profile for the one closest segment if the projection is not adjacent to two of the segments that are non-parallel;
determining a weighted travel-effort profile based on the travel-effort profile for two non-parallel segments and applying the forces to the haptic gear shifter if the projection is adjacent to two of the segments that are non-parallel; and
applying collision detection forces to prevent the haptic gear shifter from leaving a boundary of travel if a hard constraint collision is detected.
